(19) United States
(12) Patent Application Publication
(10) Pub. No.: US 2026/0178253 A1
(43) Pub. Date: Jun. 25, 2026

(54) NON-TRANSITORY COMPUTER-READABLE STORAGE MEDIUM STORING PRINT CONTROL PROGRAM, TERMINAL DEVICE, AND PRINT CONTROL METHOD

(71) Applicant: SEIKO EPSON CORPORATION, Tokyo (JP)

(72) Inventor: Yusuke YAMADA, Shiojiri (JP)

(21) Appl. No.: 19/430,392

(22) Filed: Dec. 23, 2025

(30) Foreign Application Priority Data
Dec. 25, 2024 (JP) 2024-228616

(51) Int. Cl. G06F 3/12; G06K 15/02

(52) U.S. Cl. CPC G06F 3/1259; G06F 3/1207; G06K 15/1836

(57) ABSTRACT

A non-transitory computer-readable storage medium stores a print control program. The control program causes a computer to function as a first processing section that transmits, in response to a print request for print target data, first data in a first data format generated based on the print target data to a print apparatus, and a second processing section that transmits second data to a print information management server in response to the print request, the second data being generated based on the print target data and being in a second data format having a smaller data size than the first data.

The present application is based on, and claims priority from JP Application Serial Number 2024-228616, filed Dec. 25, 2024, the disclosure of which is hereby incorporated by reference herein in its entirety.

### BACKGROUND

### 1. Technical Field

The present disclosure relates to a non-transitory computer-readable storage medium storing a print control program, a terminal device, and a print control method.

### 2. Related Art

JP-A-2006-65791 describes a technique for a registrant who has registered file information (document) to grasp a print status (unprinted/printed) of a user of the file information.

A technique capable of providing information on printing to another device in an environment in which a terminal device causes a print apparatus to perform printing by using a general-purpose printer driver has been desired.

### SUMMARY

According to an aspect of the present disclosure, a non-transitory computer-readable storage medium stores a print control program that causes a computer to function as a first processing section that transmits, in response to a print request for print target data, first data in a first data format generated based on the print target data to a print apparatus, and a second processing section that transmits second data to a print information management server in response to the print request, the second data being generated based on the print target data and being in a second data format having a smaller data size than the first data.

According to another aspect of the present disclosure, a terminal device includes a first processing section that transmits, in response to a print request for print target data, first data in a first data format generated based on the print target data to a print apparatus, and a second processing section that transmits second data to a print information management server in response to the print request, the second data being generated based on the print target data and being in a second data format having a smaller data size than the first data.

According to a further aspect of the present disclosure, a print control method includes transmitting from a first processing section, in response to a print request for print target data, first data in a first data format generated based on the print target data to a print apparatus, and transmitting from a second processing section, second data to a print information management server in response to the print request, the second data being generated based on the print target data and being in a second data format having a smaller data size than the first data.

### BRIEF DESCRIPTION OF THE DRAWINGS

FIG. 1 is a block diagram illustrating a configuration of a print system.

FIG. 2 is a sequence diagram illustrating an example of a print sequence.

FIG. 3 is a sequence diagram illustrating the example of the print sequence.

FIG. 4 is a sequence diagram illustrating the example of the print sequence.

FIG. 5 is a sequence diagram illustrating an example of a print sequence.

FIG. 6 is a sequence diagram illustrating an example of a print sequence.

FIG. 7 is a sequence diagram illustrating an example of a print sequence.

### DESCRIPTION OF EMBODIMENTS

Here, embodiments of the present disclosure will be described in the following order.
1 Configuration of Print System
1-1 Configuration of Print Apparatus
1-2 Configuration of Print Information Management Server
1-3 Configuration of Terminal Device
2 Print Sequence
3 Other Embodiments

### 1 Configuration of Print System

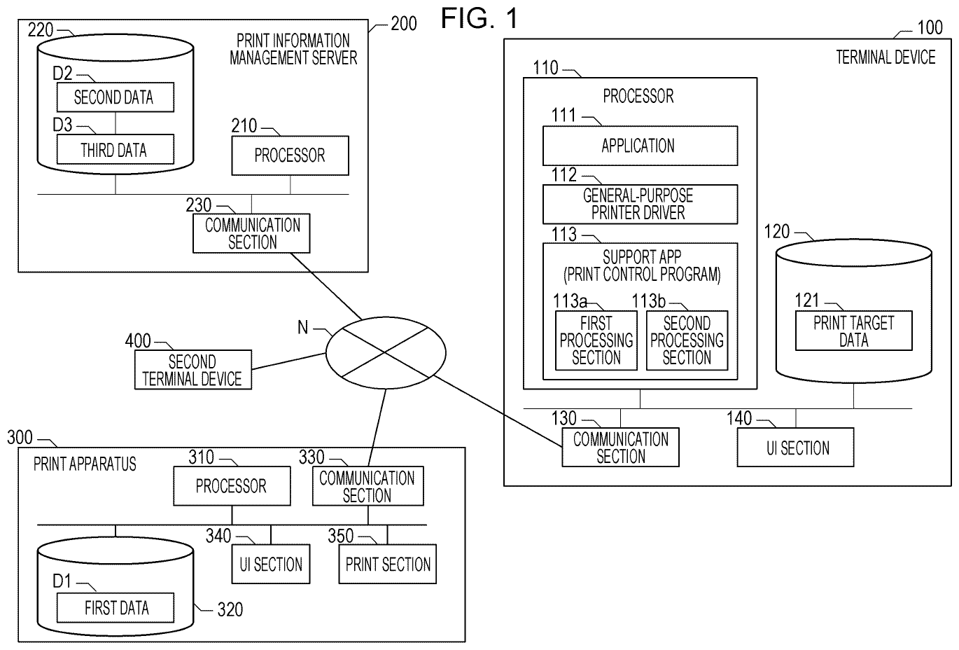

FIG. 1 is a block diagram illustrating an example of a configuration of a print system including a terminal device 100 according to an embodiment of the present disclosure. The print system includes the terminal device 100, a print information management server 200, and a print apparatus 300. The terminal device 100 is an information processing apparatus having a communication function, such as a personal computer (PC), a smartphone, or a tablet terminal, and is an apparatus used by a user who requests printing. The terminal device 100 can communicate with the print information management server 200 and the print apparatus 300 via a network N, such as a LAN or the Internet. When the user operates the terminal device 100 to request the print apparatus 300 to perform printing of print target data 121, the terminal device 100 transmits to the print apparatus 300 first data D1 obtained by converting the print target data 121 into a format suitable for printing by the print apparatus 300, and the print apparatus 300 performs printing based on the first data D1. The print information management server 200 accumulates the second data D2 and the third data D3 generated by converting the print target data 121, which is a conversion source of the first data D1 and which is image data representing a printed matter in the print apparatus 300. Hereinafter, configurations of the individual devices will be described.

### 1-1 Configuration of Print Apparatus

The print apparatus 300 includes a processor 310, a storage medium 320, a communication section 330, a UI section 340, and a print section 350. The processor 310 includes a CPU, a ROM, a RAM (not illustrated), and controls the individual sections of the print apparatus 300 by executing a control program stored in the storage medium 320. Note that the processor 310 may be configured by a single chip, may be configured by a plurality of chips, or may be configured as an SoC together with various functional blocks for operating the print apparatus 300. Furthermore, an ASIC may be employed instead of the CPU, or the CPU and the ASIC may cooperate with each other. When each of the devices according to this embodiment includes a processor, the processor may be realized in various forms, similarly to the processor 310.

The storage medium 320 stores various programs to be executed by the processor 310 and control data. In addition, in an operation process of the print system, first data D1 which is a print target transmitted from the terminal device 100 is stored. The communication section 330 includes a circuit used for communication with other devices in accordance with various wired or wireless communication protocols. In this embodiment, the print apparatus 300 can communicate with the terminal device 100 via the communication section 330. The UI section 340 includes a touch panel display and keys for displaying various types of information to a user and inputting a user operation.

The print section 350 includes an actuator, a driving component, a mechanical component, and various sensors for detecting a state of the print apparatus 300 in order to execute printing by discharging ink onto a print medium. Examples of the sensors include a sensor that detects the number of remaining print media, a sensor that detects clogging in a transport path of print media, and a sensor that detects an amount of remaining ink. The processor 310 executes printing by controlling the print section 350 based on the print data. In this embodiment, it is assumed that the print section 350 performs printing by an ink jet method, but the printing method is not limited thereto.

When receiving the first data D1, which is print data, from the terminal device 100 via the communication section 330, the processor 310 controls the print section 350 based on the first data D1 and executes printing. In addition, the processor 310 can transmit information indicating progress and success/failure of the print job and a state of the print apparatus 300 to the terminal device 100 via the communication section 330. The information indicating the progress is used by the terminal device 100 to determine what degree a print job requested by the terminal device 100 to the print apparatus 300 has progressed. For example, when printing in units of pages transmitted from the terminal device 100 is completed, the processor 310 notifies the terminal device 100 of information indicating the progress of a print job by transmitting information indicating that the printing of the pages is completed to the terminal device 100. The information indicating the success/failure of printing is used by the terminal device 100 to determine whether printing of the print job requested by the terminal device 100 to the print apparatus 300 has been completed without an error up to a final page. For example, as in the case of the above-described progress, when the printing in units of pages transmitted from the terminal device 100 is completed, the information indicating that the printing of in units of pages is completed is transmitted to the terminal device 100, and thus the terminal device 100 can acquire that the printing in units of pages is completed using the information, and can regard that the printing has been successfully performed when the printing of the last page of the print job is completed. Moreover, the information indicating the state of the print apparatus 300 is information that can be detected by the various sensors included in the print apparatus 300 or a processing state of the print apparatus 300 which is managed by the control program of the print apparatus 300, for example. More specifically, for example, the information includes information on run-out of print media, information on run-out of ink, and a state in which the print medium is jammed. The information indicating the state of the print apparatus 300 may further include information indicating that the printing is in progress or indicating a standby state while the above-described errors that prevent execution of printing do not occur. The information indicating the progress and success/failure of the print job and the state of the print apparatus 300 may be transmitted from the print apparatus 300 to the terminal device 100 when the progress, success/failure, or the state changes, or the print apparatus 300 may return the information to the terminal device 100 in response to an inquiry from the terminal device 100.

### 1-2 Configuration of Print Information Management Server

The print information management server 200 is a server computer including a processor 210, a storage medium 220, and a communication section 230. In this embodiment, the processor 210 can communicate with the terminal device 100 or a second terminal device 400 to be described later via the communication section 230. The processor 210 can execute various programs including a print information management program stored in the storage medium 220.

By executing the print information management program, the processor 210 acquires various types of print information related to printing performed by the print apparatus 300 from the terminal device 100, and stores the print information in the storage medium 220. The print information stored in the storage medium 220 includes second data D2 and third data D3.

Furthermore, the processor 210 executes the print information management program to transmit the second data D2 and the third data D3 to the second terminal device 400 in response to a browsing request issued by the second terminal device 400 described later. The second terminal device 400 displays the second data D2 and the third data D3 acquired from the print information management server 200 on a display section to allow the user to view an image representing a printed matter in the print apparatus 300 as electronic data.

### 1-3 Configuration of Terminal Device

The terminal device 100 is a computer including a processor 110, a storage medium 120, a communication section 130, and a UI section 140. The processor 110 can execute programs, such as an operating system (OS), a general-purpose printer driver 112, and a support App 113 stored in the storage medium 120, and various application programs including an application 111.

The storage medium 120 is a storage device, such as a hard disk drive, a solid state drive, or another memory. The storage medium 120 stores various programs including the OS, the general-purpose printer driver 112, the support App 113, and the application 111. The storage medium 120 stores various files that can be displayed or edited by the application 111 or the like. The various files may be print target data 121.

The communication section 130 includes a communication interface that performs communication with other devices in accordance with various wired or wireless protocols. In this embodiment, the terminal device 100 can communicate with the print information management server 200 and the print apparatus 300 via the communication section 130.

The UI section 140 includes a display and keys. Furthermore, a device, such as a mouse, may be connected via the communication section 130. Moreover, the display may be a touch panel display. The processor 110 displays various types of information on the display and receives an operation performed on an input section, such as the keys, the mouse, or the touch panel.

The general-purpose printer driver 112 is an OS-standard printer driver and is provided by a vendor that provides the OS. For example, the general-purpose printer driver 112 is a standard printer driver for the Windows® OS. The general-purpose printer driver 112 is a program capable of causing various types of print apparatus to execute printing.

The support App 113 as a print control program is an application program for assisting the general-purpose printer driver 112 and causing the processor 110 to execute print control suitable for the capabilities of a target print apparatus or print control for realizing a vendor-specific function of the print apparatus. The support App 113 is provided by a vendor of the print apparatus or the like. The support App 113 is also called a Print Support Application (PSA).

The processor 110 functions as a first processing section 113a and a second processing section 113b by executing the support App 113. The function of the first processing section 113a causes the processor 110 to transmit the first data D1 of a first data format generated based on the print target data 121, to the print apparatus 300 in response to a print request for the print target data 121. In a case where the support App 113 is not used, the general-purpose printer driver 112 generates print data for causing the print apparatus 300 to execute printing of the print target data 121 based on the print target data 121 and transmits the print data to the print apparatus 300 so as to cause the print apparatus 300 to execute printing of the print target data 121. In this embodiment, the function of the first processing section 113a enables the processor 110 to perform processing for realizing a unique function of the print apparatus 300 on the print data generated by the general-purpose printer driver 112 (or intermediate data generated in the process of generating the print data) to generate the first data D1 and transmit the first data D1 to the print apparatus 300. The print apparatus 300 can execute printing reflecting the unique function of the print apparatus 300 based on the first data D1. Therefore, the general-purpose printer driver 112 can activate the support App 113 and perform data transmission and reception with the support App 113.

Furthermore, the function of the second processing section 113b causes, in response to the print request for the print target data 121, the processor 110 to transmit, to the print information management server 200, the second data D2 of a second data format that is generated based on the print target data 121 and that has a smaller data size than the first data D1. That is, the processor 110 generates the second data D2 for browsing the print target data 121 based on intermediate data generated in the process of generating the first data D1 from the print target data 121, and transmits the second data D2 to the print information management server 200. Note that, in this embodiment, in addition to the second data D2, the third data D3, which is thumbnail image data, is also generated and transmitted to the print information management server 200.

Therefore, according to this embodiment, the processor 110 can cause the print information management server 200 to acquire the second data D2 in accordance with the print control program. As a result, the processor 110 which executes the print control program can cause the print information management server 200 to realize an information providing service relating to printing in the print apparatus 300 using the second data D2. Furthermore, the second data D2 transmitted to the print information management server 200 is smaller in size than the first data D1, and therefore, an amount of data stored in the print information management server 200 can be reduced compared to when the first data D1 is transmitted to the print information management server 200.

Hereinafter, a print sequence in this embodiment will be described in detail.

### 2 Print Sequence

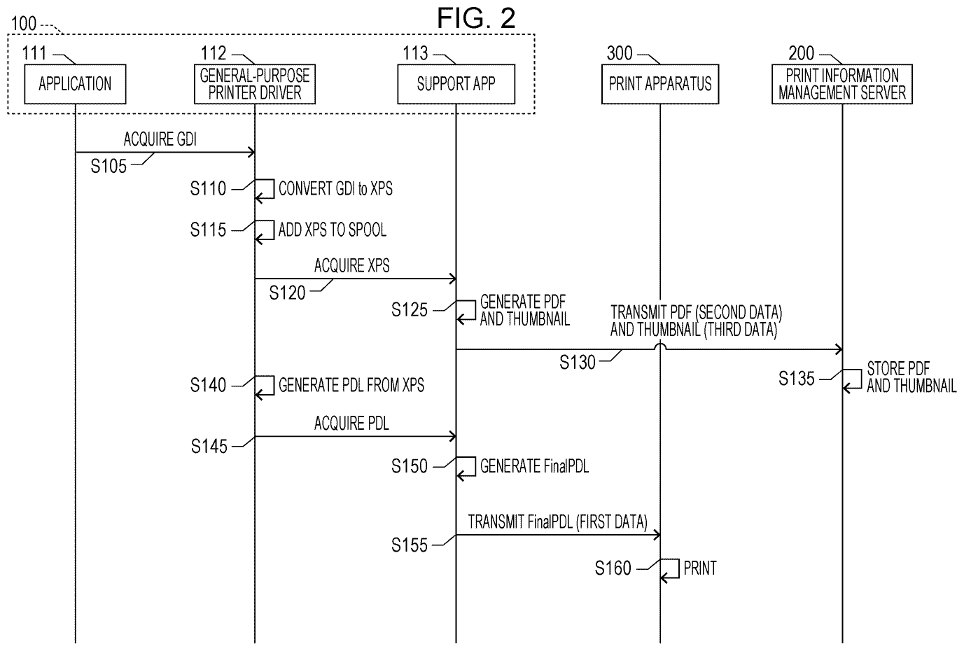

FIG. 2 is a sequence diagram illustrating an example of a print sequence according to this embodiment. In FIG. 2, processes of the application 111, the general-purpose printer driver 112, and the support App 113 are executed by the processor 110 of the terminal device 100. The application 111 is an application program that can print display data of an opened file, and may be, for example, a document generation application.

When the user opens a file with the application 111 and selects printing from a menu of the application 111, the processor 110 transmits a print request to the general-purpose printer driver 112. The file opened by the application 111 corresponds to the print target data 121. The processor 110 executing the general-purpose printer driver 112 receives the print request and displays a setting section for selecting a print apparatus as an output destination, designating a page to be printed, setting the number of copies to be printed, and the like. When the user selects the print apparatus 300 as an output destination, makes other settings, and selects execution of printing, the general-purpose printer driver 112 acquires, from the application 111, data in a graphics device interface (GDI) format representing an image of the file opened by the application 111 (step S105), converts the data in the GDI format into data in an XML paper specification (XPS) format (step S110), and spools the data in the converted XPS format in a storage medium (step S115).

The processor 110 that executes the support App 113 acquires the spooled data in the XPS format by a function of the second processing section 113b (step S120), converts the data in the XPS format into data in the PDF format, and generates thumbnail image data (step S125). The data in the PDF format as the second data D2 is vector data in a vector format as a second data format. The thumbnail image data corresponds to the third data D3. In this embodiment, the third data D3 is raster data generated based on the print target data 121 and is lower-resolution raster data than the first data D1.

The processor 110 executing the support App 113 transmits the generated data in the PDF format (second data D2) and the thumbnail image data (third data D3) to the print information management server 200 by the function of the second processing section 113b (step S130). The print information management server 200 stores, in the storage medium 220 of the print information management server 200, the second data D2 in the PDF format and the third data D3 which is the thumbnail image data that are acquired from the support App 113 of the terminal device 100 (step S135). That is, the print information management server 200 stores the received second data D2 and the received third data D3 in the storage medium 220 in association with each other.

On the other hand, when the data in the XPS format is spooled in step S115, the processor 110 executing the general-purpose printer driver 112 converts the data in the XPS format into data in a page description language (PDL) format (step S140). The data in the PDL format is raster data in a raster format (first data format). The processor 110 executing the support App 113 displays a UI screen of the support App 113 on the display of the UI section 140 when acquiring the data in the PDL format generated by the general-purpose printer driver 112. On the UI screen, the user can select whether to apply a watermark function and other functions of the print apparatus 300, for example. When the user selects one of these functions, the processor 110 modifies the data in the PDL format obtained in step S145 to reflect the function selected by the user, and generates final data in the PDL format (Final PDL) as the first data D1 (step S150). The final data in the PDL format as the first data D1 is raster data in a raster format (first data format).

Note that the process in step S140 and step S145 in the general-purpose printer driver 112 may be skipped, and the support App 113 may generate the final data in the PDL format (Final PDL) based on the data in the XPS format acquired in step S120 (step S150). In any case, after performing step S150, the processor 110 transmits the final data in the PDL format as the first data D1 to the print apparatus 300 selected as the output destination by the user (step S155). When receiving the first data D1, the print apparatus 300 controls the print section 350 to perform printing based on the first data D1 (step S160). Note that the final data in the PDL format (Final PDL) as the first data D1 may be transmitted to the print apparatus 300 via the general-purpose printer driver 112.

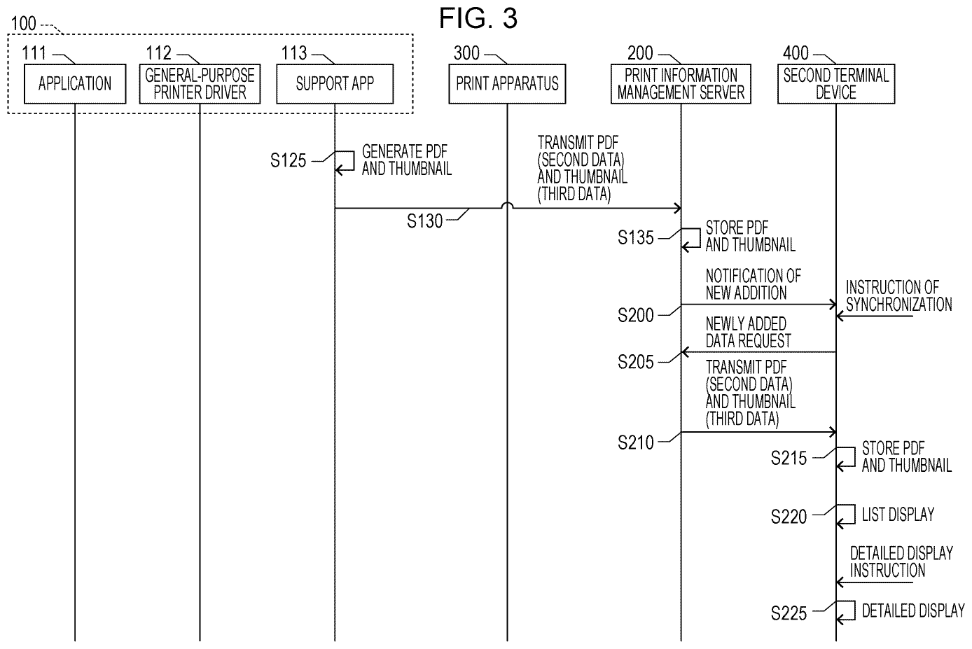

FIG. 3 is a continuation of the sequence illustrated in FIG. 2, and is a sequence illustrating an example of utilization of the second data D2 and the third data D3 accumulated in the print information management server 200 after step S135 in FIG. 2. A process in step S125 to step S135 in FIG. 3 is the same process as the process of the same symbols in FIG. 2. The second terminal device 400 is used to view the second data D2 indicating an image of a printed matter printed by the print apparatus 300 and accompanying print information, which are accumulated in the print information management server 200, and a browsing application for browsing the information is installed in the second terminal device 400. The browsing application may have not only a function of browsing the second data D2 but also a function of adding data, such as a tag or a memo handwritten by the user to the second data D2.

The second terminal device 400 may be, for example, a terminal operated by an administrator of the print apparatus 300. Alternatively, the second terminal device 400 may be another terminal operated by a user who has requested printing from the terminal device 100. The second terminal device 400 may be a PC, a tablet terminal, or a smartphone. The second terminal device 400 includes a processor, a storage medium, a communication section, and a touch panel display, which are not illustrated.

When the print information management server 200 stores the data in the PDF format as the second data D2 and the thumbnail image data as the third data D3 in step S135, the print information management server 200 notifies the second terminal device 400 that the second data D2 and the third data D3 have been newly added (step S200). For example, a push notification to the browsing application of the second terminal device 400 is executed.

In response to the notification in step S200, for example, when the user of the second terminal device 400 instructs to synchronize the data stored in the print information management server 200 with the data of the second terminal device 400, the second terminal device 400 requests the print information management server 200 for the newly added data using the browsing application (step S205). The second terminal device 400 requests the print information management server 200 to transmit data which is not stored in the second terminal device 400 and is stored in the print information management server 200. In response to the request in step S205, the print information management server 200 transmits the newly added data in the PDF format as the second data D2 and the newly added thumbnail image data as the third data D3 to the second terminal device 400.

When receiving the second data D2 and the third data D3 in step S210, the second terminal device 400 stores the received data in the storage medium of the second terminal device 400 (step S215). As a result, the second data D2 and the third data D3 stored in the storage medium 220 of the print information management server 200 are synchronized with the second data D2 and the third data D3 stored in the storage medium of the second terminal device 400. Note that, in the second terminal device 400, the second data D2 and the third data D3 generated based on the print target data 121 which is a generation source of the second data D2 are also stored in the storage medium of the second terminal device 400 in association with each other.

Subsequently, the second terminal device 400 displays a list of thumbnail images of printed matters in the print apparatus 300 by using the thumbnail image data as the third data D3 stored in the storage medium of the second terminal device 400 (step S220). Since the third data D3 is raster data having a lower definition than the first data D1, a drawing processing time for displaying the third data D3 on the screen can be reduced compared to a case where the third data D3 is not low-definition data or a case where the third data D3 is not raster data. In the configuration in which the thumbnail images are used in the browsing application of the second terminal device 400, the support App 113 has a function of accumulating the third data D3 having a lower definition than the first data D1 in the print information management server 200, and thus it is possible to improve convenience in the second terminal device 400.

The thumbnails are displayed for individual print jobs. For example, in an initial state, a thumbnail of a top page in a print job is displayed. In a case where a plurality of print jobs have already been executed in the print apparatus 300, a plurality of thumbnails are displayed as a list. When the user selects a thumbnail image of the third data D3 to be checked in detail from the list, the second terminal device 400 performs detailed display (step S225). That is, the second terminal device 400 displays an image on the display of the second terminal device 400 based on the second data D2 corresponding to the selected third data D3. The second data D2 is vector data in this embodiment. Therefore, for example, when the user performs an operation of enlarging or reducing an image, it is possible to prevent the image quality of the display image after the enlargement or reduction from being deteriorated. In the configuration in which an image indicating a printed matter can be viewed in detail in the browsing application of the second terminal device 400, the convenience of the second terminal device 400 can be improved since the support App 113 has the function of accumulating the second data D2, which is vector data, in the print information management server 200. Note that when one or more pages are included in one print job, the detailed display is also performed in a mode indicating that these pages belong to the same print job.

Note that step S200 may be omitted. In other words, the user of the second terminal device 400 may start the browsing application at an arbitrary timing, issue an instruction to acquire latest data at an arbitrary timing, acquire the print information including the second data D2 stored in the print information management server 200, and browse the print information on the second terminal device 400.

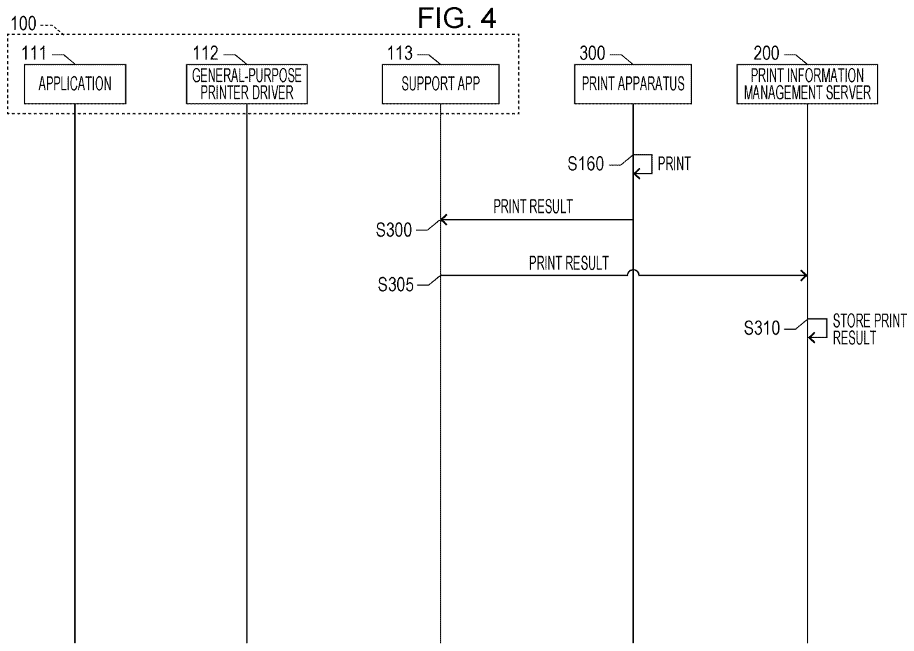

FIG. 4 is a continuation of the sequence illustrated in FIG. 2, and is a sequence illustrating an example of processing after step S160 in FIG. 2. When the print apparatus 300 executes printing in step S160, the print apparatus 300 transmits information indicating a print result to the support App 113 of the terminal device 100 (step S300). The information indicating the print result may be transmitted from the print apparatus 300 to the general-purpose printer driver 112, and the support App 113 may acquire the information indicating the print result from the general-purpose printer driver 112.

The information indicating the print result includes information indicating success or failure of the printing. Furthermore, the information indicating the print result includes information indicating a state of the print apparatus 300. For example, in a case where printing fails due to an error, such as a shortage of the number of remaining print media, clogging of a print medium, or a shortage of an amount of remaining ink, information indicating these errors is notified as information indicating the state of the print apparatus 300 in the information indicating the print result.

When the processor 110 executing the support App 113 acquires the information indicating the print result in step S300, the processor 110 displays the information indicating the print result on the terminal device 100. In addition, when acquiring information indicating the print result in step S300, the processor 110 transmits the information to the print information management server 200 (step S305). That is, the processor 110 notifies the print information management server 200 of success or failure of printing in the print apparatus by the function of the second processing section 113b. In addition, the processor 110 notifies the print information management server 200 of the state of the print apparatus by the function of the second processing section 113b. The print information management server 200 stores the received information indicating the print result in association with the second data D2 stored in step S135 of FIG. 2 (step S310).

Although not illustrated in FIG. 4, when the user of the second terminal device 400 activates the browsing application and instructs synchronization with the print information management server 200, the print information accumulated in the print information management server 200 and the print information stored in the second terminal device 400 are synchronized with each other, and a list of the third data D3, which is a thumbnail image, is displayed. When the user selects a thumbnail of which the details thereof are to be checked from the displayed list, information indicating the print result corresponding to the second data D2 is displayed on the display together with the second data D2 corresponding to the selected third data D3. In this way, since the print control program has the function of transmitting the information indicating success or failure of printing, the user of the second terminal device 400 can recognize success or failure of printing corresponding to the displayed second data D2. In addition, since the print control program has the function of transmitting information indicating a state of the print apparatus 300, the user of the second terminal device 400 can recognize information, such as an error occurring in the print apparatus 300. Note that, as the information indicating success or failure of printing or the information indicating a state of the print apparatus 300, for example, when information indicating that printing has failed due to a paper jam in the middle of a print job is transmitted to the print information management server 200, the print information management server 200 can provide a service using an image of a page for which printing has been completed. For example, in the browsing application of the second terminal device 400, an image of a page for which printing has been completed is displayed using the second data D2 or the third data D3 of the page, and a page for which printing has not been completed is displayed as a gray image. In this way, the user can recognize that the print job has failed in the middle since a page of a gray image is included. In addition, for example, by displaying a reason why the printing is not completed in association with the page of the gray image, the user can recognize information, such as an error. Since it is possible to guide the information by using the image of the page, for example, it is more convenient for the user than a case where the success or failure of printing or the state of the print apparatus 300 is simply guided by character information. For example, it is easy for the user of the second terminal device 400 to determine that pages essential for the user have been printed and thus the remaining pages may be left as printing failure, or to determine that the essential pages have not been printed and thus need to be printed again by another print apparatus.

Furthermore, by the function of the second processing section 113b, the processor 110 notifies the print information management server 200 of the progress of the first data generation process. In FIG. 2, step S110 to step S160 are processes performed on a page-by-page basis. When the print target data 121 includes a plurality of pages, the processor 110 acquires information indicating a latest page number for which generation of the first data D1 of step S150 has been completed, and transmits the acquired information to the print information management server 200. Alternatively, the processor 110 acquires information indicating the latest page number for which spooling has been completed in step S115, and transmits the acquired information to the print information management server 200. Alternatively, in a case where step S300 to step S310 of FIG. 4 are also performed on a page-by-page basis, the processor 110 may notify the print information management server 200 of the progress of printing by transmitting a latest page number for which printing has been completed in step S305.

In this way, when the print information management server 200 is notified of the progress of printing, the print information management server 200 can provide a service using an image of a page for which printing has been completed. For example, in the browsing application of the second terminal device 400, images of pages for which printing has been completed may be displayed using the second data D2 or the third data D3 of the pages, and pages after the last page for which printing has been completed may be displayed, for example, as gray images. In this way, the user can recognize the pages for which the printing has been completed by the images of the pages.

### 3 Other Embodiments

The above embodiment is an example for embodying the present disclosure, and various other embodiments may be adopted. For example, the print control program may be applied not only to Windows® but also to application programs for extending a function of a general-purpose printer driver in various OSs.

In a case where the first data is in a raster format indicating color information for each pixel, the color information may be indicated by, for example, a grayscale value of an RGB3-channel, or may be indicated by a grayscale value for each ink color of a target print apparatus. Alternatively, the color information may indicate whether an ink droplet is discharged or indicate a size of an ink droplet for each pixel.

The second data may be data in the second data format that is generated from the print target data and has a smaller data size than the first data. The second data may be vector data generated based on the print target data. The second data may be data in a PDF format, an XPS format, an SVG format, or the like. The second data format is not limited to a vector format. For example, the second data format may be the JPEG format, and the second data may be data in the JPEG format. Therefore, for example, the first data in the raster format may be transmitted to the print apparatus 300, and the data in the JPEG format may be transmitted to the print information management server 200.

The second processing section 113b may transmit at least the second data D2 to the print information management server 200, and the generation of the third data D3 and the transmission of the third data D3 to the print information management server 200 may be omitted. When the third data D3 is generated, the third data D3 may be generated for all the pages included in the print job, or the third data D3 may be generated for only a first page of the print job, for example.

In addition to the second data D2 and the third data D3, the second processing section 113b may transmit various types of information related to the printing of the print target data to the print information management server 200 and cause the print information management server 200 to store the information. For example, the identification information and an IP address of the terminal device 100, a date and time when a print request is received from the user in the terminal device 100, the identification information of the user who requests the printing, a date and time when the printing is completed in the print apparatus 300, and the like may also be transmitted to the print information management server 200.

Furthermore, the second processing section 113b may be configured to notify the print information management server of the identification information of the print apparatus. In the configuration example illustrated in FIG. 1, the single print apparatus 300 and the single terminal device 100 are illustrated, but there may be a plurality of print apparatuses that can be used by the terminal device 100. When the user of the terminal device 100 makes a print request for a file opened by the application 111, the user selects a print apparatus as an output destination by the general-purpose printer driver 112. The support App 113 acquires information indicating the print apparatus of the output destination from the general-purpose printer driver 112, and also transmits the information indicating the print apparatus of the output destination to the print information management server 200 in step S130 of FIG. 2. Since the print control program has such a function, it is possible to provide the server with the identification information of the print apparatus 300 that has executed the printing corresponding to the second data D2. The second data D2 and the identification information of the print apparatus 300 associated with the second data D2 may be used, for example, by an administrator for investigation when information leakage occurs in a company organization.

In addition to the method in which the user selects one specific print apparatus as the print apparatus of the output destination by the general-purpose printer driver 112, a configuration may be adopted in which a group including a plurality of print apparatuses of the same type can be selected. When the user selects the group as the print apparatus of the output destination, the support App 113 may select a printable print apparatus (for example, a print apparatus that is not in a printing state, is not stopped due to an error, or has a sufficient number of remaining printing media or a sufficient amount of remaining ink) from among the print apparatuses included in the group, and may transmit the first data D1 to the selected print apparatus to cause the selected print apparatus to perform printing. In this case, the identification information of the print apparatus 300 selected as the output destination by the support App 113 is transmitted to the print information management server 200.

The administrator of the organization may register the identification information of the print apparatus permitted to perform printing in the print information management server 200 in advance. In this case, the second processing section 113b may inquire of the print information management server 200 whether the identification information of the print apparatus 300 to be used for printing has been registered in advance, and the first processing section 113a may acquire a result of the inquiry from the second processing section 113b and transmit the first data D1 to the print apparatus 300 when the identification information of the print apparatus 300 has been registered in advance and may not transmit the first data D1 to the print apparatus 300 when the identification information has not been registered.

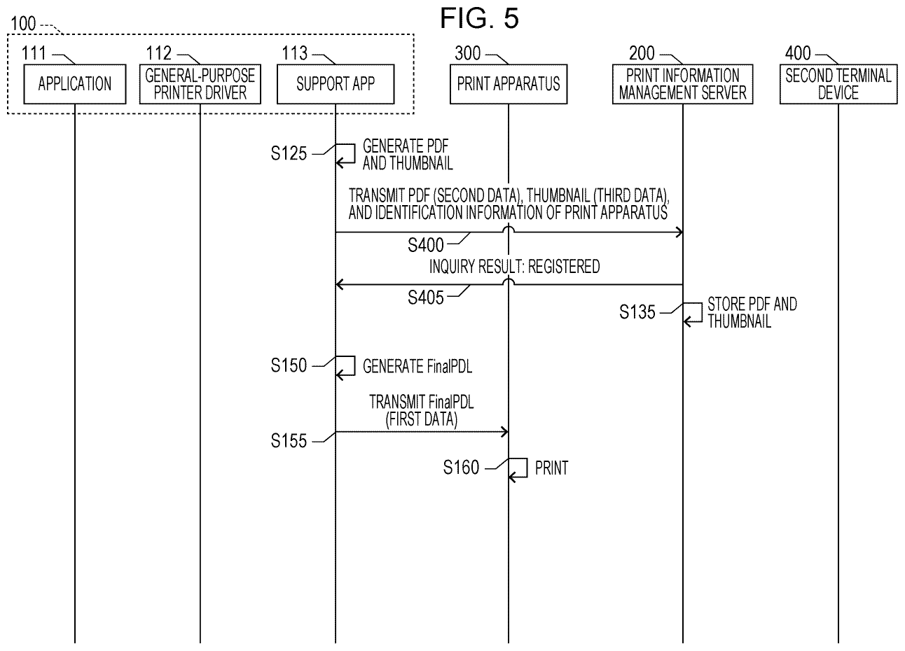

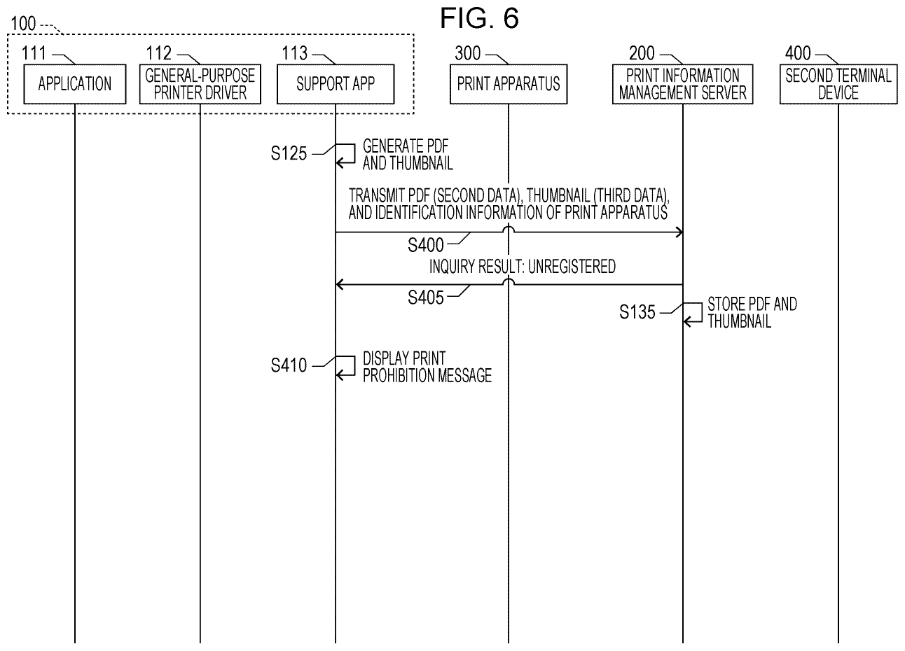

For example, FIG. 5 illustrates a sequence example in a case where registration has been performed, and FIG. 6 illustrates a sequence example in a case where registration has not been performed. As illustrated in FIG. 5, as in step S125 of FIG. 2, when the second data D2 and the third data D3 are generated by the support App 113, the support App 113 transmits the identification information of the print apparatus 300 of the output destination to the print information management server 200 together with the second data D2 and the third data D3 (step S400). The print information management server 200 determines whether the received identification information has been registered in the print information management server 200, and returns a result of the determination to the support App 113. In FIG. 5, when the query result (determination result) indicates that the received identification information has been registered, the print information management server 200 returns the determination result indicating the registration to the support App 113 (step S405). In the print information management server 200, the identification information of the print apparatus 300 of the output destination is also stored together with the second data D2 and the third data D3 in the storage process of step S135.

When receiving the determination result indicating that registration has been performed in step S405, the support App 113 executes step S150 and the subsequent steps as in FIG. 2. That is, the processor 110 generates the first data D1 (step S150), and transmits the generated first data D1 to the print apparatus 300 which is determined to be registered and selected as the output destination by the user (step S155). As a result, printing is executed by the print apparatus 300 (step S160).

On the other hand, as illustrated in step S405 of FIG. 6, in a case where the determination result returned from the print information management server 200 indicates that the registration has not been performed, the processor 110 does not perform the suspended processes of step S150 and the subsequent steps. Therefore, when the sequences illustrated in FIGS. 5 and 6 are employed, it is possible to prevent printing using a print apparatus that is not registered in the print information management server 200 in advance. In response to the query result of step S405, the processor 110 displays a message indicating that printing may not be performed because printing is not permitted in the print apparatus selected by the user (step S410).

Note that, as illustrated in FIG. 6, even when printing may not be performed because the selected print apparatus is not registered, the second data D2 and the third data D3 for browsing the print target data 121 are transmitted to and stored in the print information management server 200 (step S135), and thus the user can view the second data D2 and the third data D3 by using the browsing application in the second terminal device 400. Note that, in the case of the example illustrated in FIG. 6, in step S135, the print information management server 200 may be configured to store information indicating that printing may not be performed because the print apparatus selected by the user is not a registered print apparatus in association with the second data D2 and the third data D3, and to display the information when the user of the second terminal device 400 browses the second data D2.

In FIG. 2, generation and transmission of the first data D1 of an M-th page (M is a positive integer of 1 or more) to be printed (first processing section 113a) and generation and transmission of the second data D2 of the M-th page (second processing section 113b) may be performed such that the latter is performed before the former, at least portions thereof may be performed in parallel, or the former may be performed before the latter. However, the latter is performed before the former in the following case.

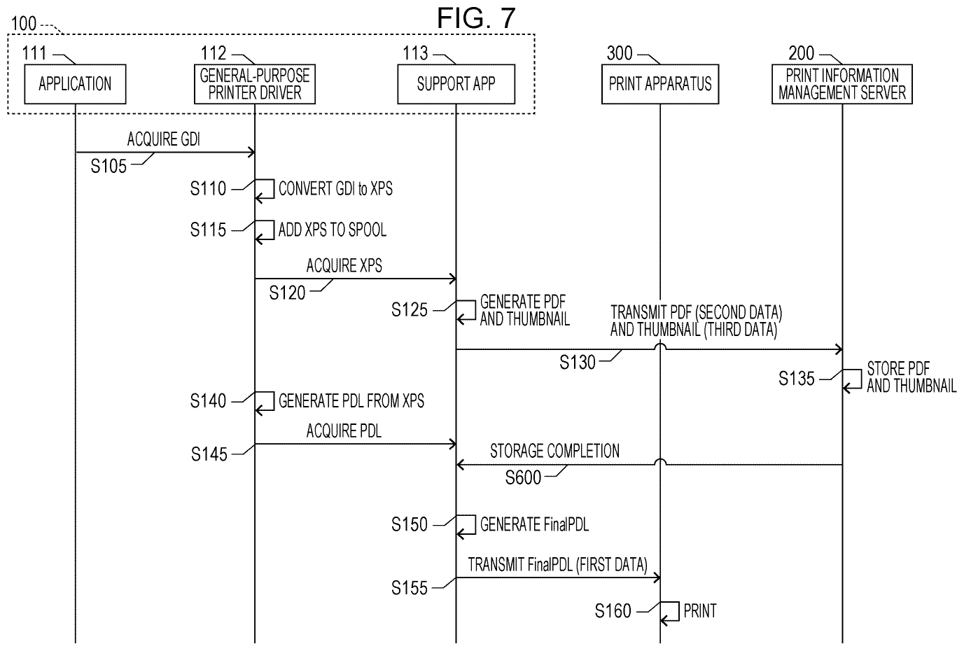

Specifically, the first processing section 113a may be configured to transmit the first data D1 to the print apparatus 300 when the transmission of the second data D2 to the print information management server 200 is completed. FIG. 7 illustrates a modification of the print sequence of FIG. 2. A difference from the print sequence illustrated in FIG. 2 is that, after the print information management server 200 stores the second data D2 and the third data D3 in step S135, a notification indicating that the storing is completed is returned from the print information management server 200 to the support App 113 (step S600). The support App 113 is different from that in the sequence of FIG. 2 in that step S150 and the subsequent processes are performed in response to the notification made in step S600. Even when the print job includes a plurality of pages, the transmission of the first data D1 of the M-th page is performed after the second data D2 of the M-th page is transmitted to and stored in the print information management server 200. If a configuration in which printing is performed regardless of whether the storage in the print information management server 200 is completed is adopted, in a case where communication with the print information management server 200 is not available, printing is completed even though print information, such as the second data D2, is not stored in the print information management server 200. In this case, the print information may not be stored, and information leakage may not be sufficiently tracked. Since the print control program has such a function, it is possible to prevent printing from being executed before the second data D2 is accumulated in the print information management server 200.

Furthermore, the above-described contents are also established as a disclosure of a terminal device that executes a print control program. In this case, the terminal device includes a first processing section that transmits, in response to a print request for print target data, first data in a first data format generated based on the print target data to a print apparatus, and a second processing section that transmits second data to a print information management server in response to the print request, the second data being generated based on the print target data and being in a second data format having a smaller data size than the first data.

In addition, the above contents are also established as a disclosure of a print control method. In this case, the print control method includes transmitting from a first processing section, in response to a print request for print target data, first data in a first data format generated based on the print target data to a print apparatus, and transmitting from a second processing section, second data to a print information management server in response to the print request, the second data being generated based on the print target data and being in a second data format having a smaller data size than the first data.

The system, the program, and the method described above may be realized as a single apparatus or may be realized by using components included in a plurality of apparatuses, and thus include various forms. Moreover, the configuration can be appropriately changed in such a manner that a portion of the configuration is software and a portion of the configuration is hardware. In addition, the disclosure may also be realized as a recording medium for recording a program for controlling the system. Undoubtedly, the recording medium for recording the program may be a magnetic recording medium or a semiconductor memory, and any recording medium to be developed in the future may be considered in the same manner.

What is claimed is:

1. A non-transitory computer-readable storage medium storing a print control program, the control program causing a computer to function as:
a first processing section that transmits, in response to a print request for print target data, first data in a first data format generated based on the print target data to a print apparatus; and
a second processing section that transmits second data to a print information management server in response to the print request, the second data being generated based on the print target data and being in a second data format having a smaller data size than the first data.

2. The non-transitory computer-readable storage medium storing the print control program according to claim 1, wherein the print control program is a print support application.

3. The non-transitory computer-readable storage medium storing the print control program according to claim 1, wherein
the first data is raster data generated based on the print target data, and
the second data is vector data generated based on the print target data.

4. The non-transitory computer-readable storage medium storing the print control program according to claim 1, wherein
the first data is raster data generated based on the print target data, and
the second processing section transmits third data, which is raster data generated based on the print target data and has a lower resolution than the first data, to the print information management server together with the second data.

5. The non-transitory computer-readable storage medium storing the print control program according to claim 1, wherein the second processing section notifies the print information management server of progress of a process of generating the first data.

6. The non-transitory computer-readable storage medium storing the print control program according to claim 1, wherein the second processing section notifies the print information management server of success or failure of printing performed by the print apparatus.

7. The non-transitory computer-readable storage medium storing the print control program according to claim 6, wherein the second processing section notifies the print information management server of a state of the print apparatus.

8. The non-transitory computer-readable storage medium storing the print control program according to claim 1, wherein the second processing section notifies the print information management server of identification information of the print apparatus.

9. The non-transitory computer-readable storage medium storing the print control program according to claim 1, wherein
the second processing section inquires of the print information management server whether the identification information of the print apparatus that is to execute printing is registered in advance, and
the first processing section transmits the first data to the print apparatus when the identification information of the print apparatus is registered in advance, and does not transmit the first data to the print apparatus when the identification information is not registered in advance.

10. The non-transitory computer-readable storage medium storing the print control program according to claim 1, wherein the first processing section transmits the first data to the print apparatus when transmission of the second data to the print information management server is completed.

11. A terminal device, comprising:
a first processing section that transmits, in response to a print request for print target data, first data in a first data format generated based on the print target data to a print apparatus; and
a second processing section that transmits second data to a print information management server in response to the print request, the second data being generated based on the print target data and being in a second data format having a smaller data size than the first data.

12. A print control method, comprising:
transmitting from a first processing section, in response to a print request for print target data, first data in a first data format generated based on the print target data to a print apparatus; and
transmitting from a second processing section, second data to a print information management server in response to the print request, the second data being generated based on the print target data and being in a second data format having a smaller data size than the first data.
